(19) United States
(12) Patent Application Publication
(10) Pub. No.: US 2007/0222275 A1
(43) Pub. Date: Sep. 27, 2007

(54) Wheel Provided With a Drive-Dependent, Exchangeable Coupling Element

(76) Inventor: Johan Vrielink, Dronten (NL)

Correspondence Address: Harness, Dickey & Pierce, Post Office Box 8910, Reston, VA, 20195, US

(21) Appl. No.: 10/580,470

(22) PCT Filed: Oct. 19, 2004
(86) PCT No.: PCT/NL04/00737

§ 371 Date: Mar. 9, 2007

(30) Foreign Application Priority Data
Nov. 25, 2003 (NL) 1024864

(51) Int. Cl. B60B 27/02

(52) U.S. Cl. 301/6.9

(57) ABSTRACT

There is disclosed a wheel (1) that comprises a hollow central body (2), in which a coupling element (6) to be coupled to a wheel shaft (5) and to the central body (2) is present. The coupling element (6) is a coupling element that is exchangeable in dependence on the fact whether the wheel shaft (5) is a driven shaft or not. In the case of a wheel driven by the wheel shaft (5), the wheel (1) comprises a insert (6-2) as the coupling element. In the case of a wheel (1) not driven via the wheel shaft (5), comprises a shaft bearing (6-1) as the coupling element. One and the same wheel can be used in a vehicle as a driven wheel but also as a non-driven wheel, which can be realised by exchanging the coupling element (6). Furthermore the wheel can be used as a front wheel, but also as a rear wheel.

The present invention relates to a wheel comprising a hollow central body, in which a coupling element for coupling to a wheel shaft and to the central body is present.

The invention furthermore relates to a vehicle provided with at least one such wheel and to a method for driving said wheel.

Such a wheel is known from EP-0 520 942. The known wheel has a hollow central body, which is connected, via spokes, to the wheel rim, around which a tyre extends. Present in said central body is a wheel shaft, which is rotatably coupled, via a coupling element fitted with detachable bearings, to a wheel housing located within said central body. The wheel is bowl-shaped, and is driven by means of an auxiliary motor that is accommodated in the space that is created by making the wheel bowl-shaped.

The object of the present invention is to provide a universally usable wheel, which may or may not be a driven wheel, for use in a vehicle.

According to the invention, the wheel is to that end characterized in that the coupling element is a coupling element that is exchangeable in dependence on the fact whether the wheel shaft is a driven shaft or not.

The vehicle as defined in claim 15 has the same characterising feature.

The wheel according to the invention has this advantage that one and the same wheel can be used as a driven wheel but also as a non-driven wheel in a respective vehicle by exchanging the coupling element. As a result, the wheel can advantageously be used as a front wheel but also as a rear wheel, after all, the driving force—usually generated by a person in the case of a bicycle, or by a motor—is transmitted to the wheel shaft and, via the coupling element that is used, to the wheel. This makes the wheel universally suitable for use in a bicycle, a reclining bicycle, a mountain bike, but also in a bicycle trailer, a velomobile, a hand-driven bike, a wheel chair or another comparable mobility product driven by man or machine.

One embodiment of the wheel according to the invention is characterized in that the wheel, in the case of a wheel driven by the wheel shaft, comprises an insert as the coupling element, whilst the wheel, in the case of a wheel not driven via the wheel shaft, comprises a shaft bearing as the coupling element.

By exchanging the insert for the shaft bearing, the wheel changes from a driven wheel—usually, but not necessarily a rear wheel—into a non-driven wheel—usually, but not necessarily a front wheel—and vice versa.

Another embodiment of the wheel according to the invention is characterized in that the central body is provided with internal coupling means to provide a rotatable or rigid coupling with the wheel shaft.

The wheel may furthermore be characterized in that it comprises a housing which is coupled to the central body in a non-rotatable manner by first coupling means, and in that the coupling element is coupled to the housing by second coupling means.

Preferably, simple teeth or splines, which enable quick mutual detachment, are used as the coupling means.

A brake for the wheel is advantageously introduced in further embodiments, which brake can be built into a housing within the hollow central body in a compact manner. A drum brake comprising brake segments and a brake backing plate is very suitable for that purpose.

A preferred embodiment of the wheel according to the invention is characterized in that the central body, the coupling element, i.e. the shaft bearing or the insert, the housing and possibly the brake are mutually detachable and are constructed as exchangeable components.

In this way it is possible to use a minimum number of wheel parts so as to achieve a maximum degree of flexibility and universality. This is very advantageous from a logistic point of view as well.

Another preferred embodiment is characterized in that the shaft bearing is a double-angle contact bearing.

In this case it will even suffice, if desired, to use a one-sided support or suspension for the wheel shaft, because such a bearing is capable of absorbing not only bearing forces but also mechanical moments.

If the wheel is furthermore configured as a dish- (bowl-) shaped wheel, it is not only possible to nest it with other wheels in a space-saving manner, but in addition sufficient space is created within the wheel circumference for accommodating a hub steering mechanism or an auxiliary motor, for example.

Tough and strong light-weight wheels are obtained by producing the universal wheel in a known manner by means of a Thixo moulding process.

According to the invention, the corresponding method according to the invention comprises the features as defined in claim 16.

The wheel according to the present invention will now be explained in more detail with reference to the figures below, in which like parts are indicated by the same numerals. In the drawing:

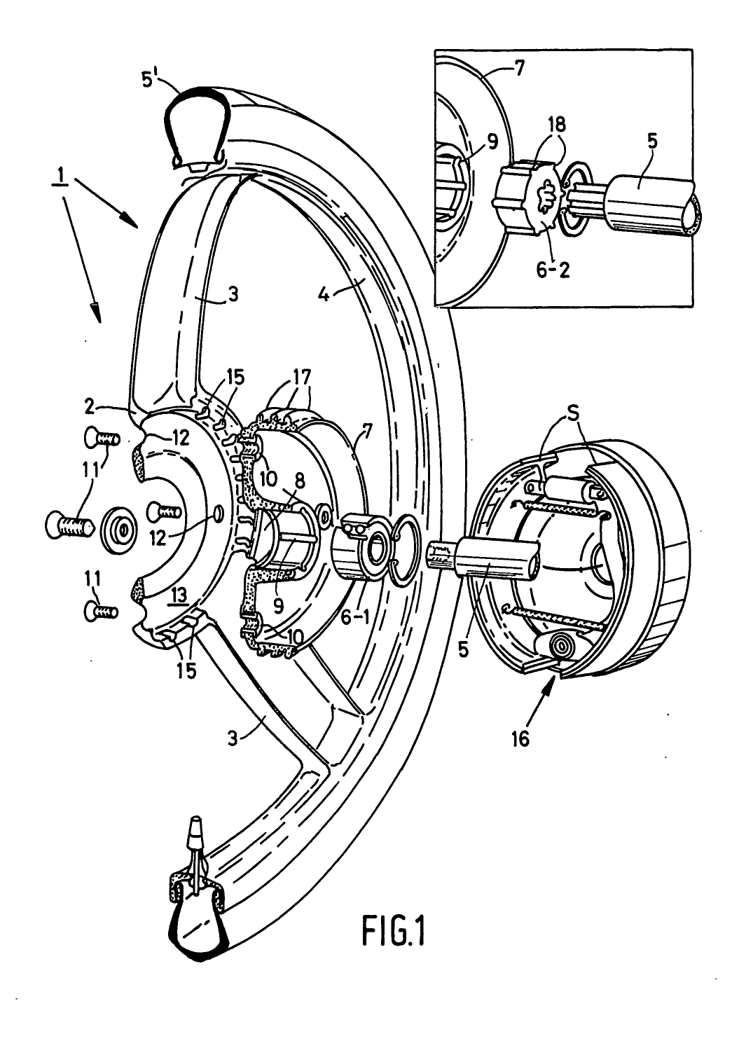

FIG. 1 shows an embodiment of a non-driven, bearing-mounted wheel according to the invention, which is furthermore provided with a brake, with the detail in FIG. 1 showing the driven wheel, which is provided with an insert;

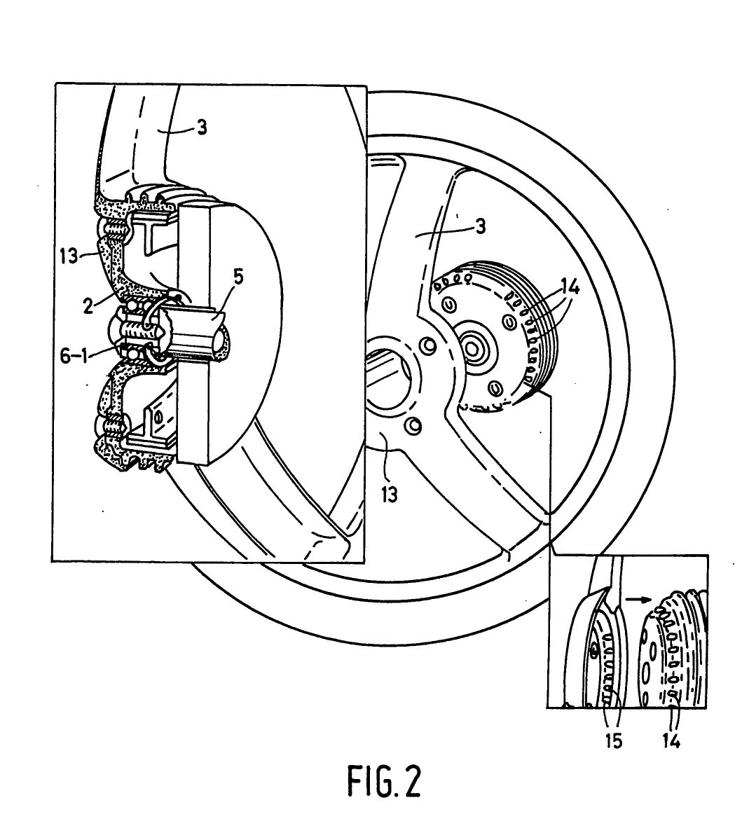

FIG. 2 shows the wheel of FIG. 1, with the detail showing a sectional view of the wheel and of the manner in which the hollow, are central wheel body and a wheel housing are connected;

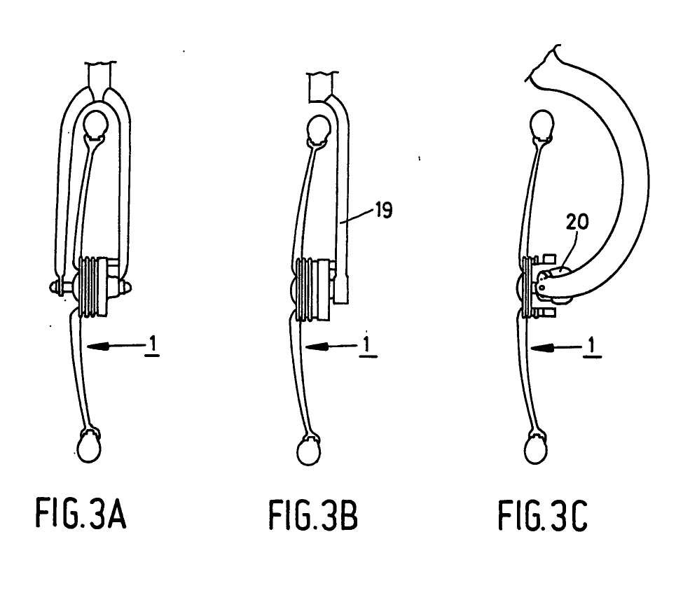

FIGS. 3A, 3B and 3C are views of wheel shaft constructions supported on two sides and on one side, respectively, for use in the wheel according to the invention; and

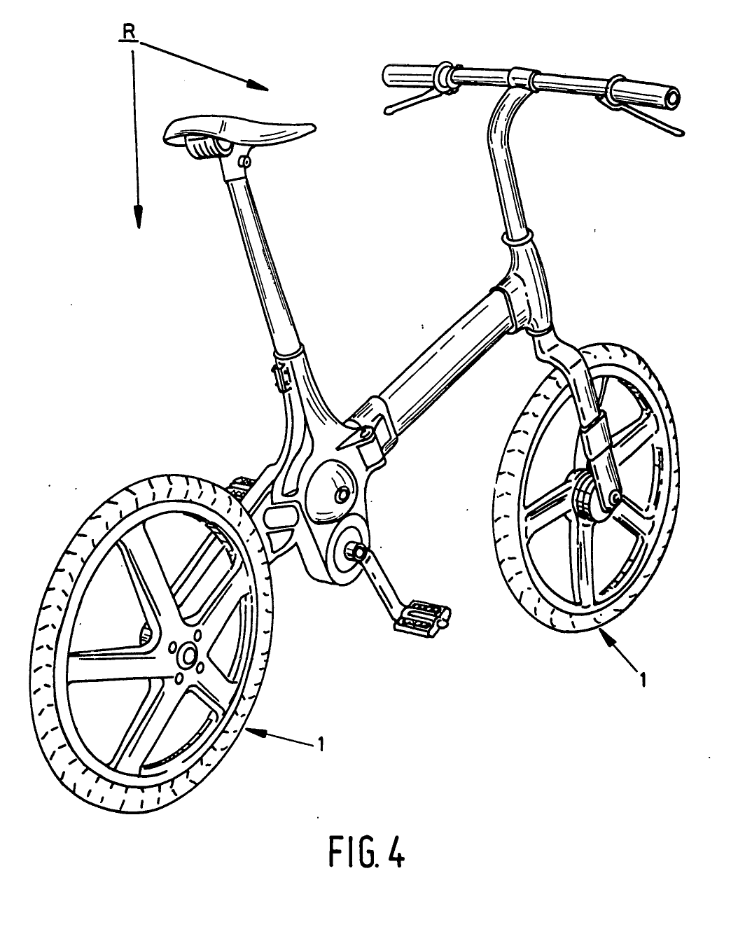

FIG. 4 shows a bicycle used as a vehicle provided with one or more wheels according to the invention.

FIG. 1 shows a wheel 1 comprising a hollow, central body 2, which is connected via spokes 3 to a wheel rim 4, over which a tyre 5′, e.g. a tubeless tyre, extends. Present in the hollow central body 2 is a wheel shaft 5, which can be driven in a known manner, for example as in a bicycle. The driven situation to be further explained yet is shown in the detail view of FIG. 1. Also a situation in which the wheel shaft 5 is not driven is possible, which situation is shown in the main view of FIG. 1. In both cases the wheel 1 may be a front wheel or a rear wheel of a so-called mobility product. The wheel comprises a bearing 6-1, which is referred to as the coupling element 6 herein. The bearing 6-1 surrounds the wheel shaft 5 and is rotatably coupled with the central body 2 via a housing 7. The housing 7 has an axial opening 8, in which the bearing 6-1 is locked or clamped in position. The bearing 6-1 can be detached from the opening 8. The housing 7 is provided with threaded holes 10, into which bolts 11 can be screwed, which bolts also extend through holes 12 formed in a flat part 13 of the central body 2. Furthermore, the outer circumference of the housing 7 and the inner circumference of the hollow central body 2 may be provided with corresponding external and internal teeth or coupling means 14 and 15, which provide a correct centration and transmission of forces. The embodiment of FIG. 1 furthermore shows the presence in the housing 7 of a brake 16, for example in the form of brake segments S and a brake backing plate. The brake is fixedly mounted on the wheel shaft 5 in a non-rotatable manner. Cooling fins 17, which function to increase the surface area, are integrated in an axial outer surface of the housing 7. In the illustrated embodiment, the wheel, which may be dish- or bowl-shaped, inter alia in order to enable simple stacking or nesting, is a non-driven front wheel of a bicycle, for example, which may be supported on one side or on two sides in a manner as shown in FIG. 3A, 3B or 3C. The bowl- or dish-shaped design of the wheel 1 is furthermore of importance in order to create space so as to enable the use of an auxiliary motor, but also the use of various types of breaks, shafts/hubs and hub steering mechanisms. FIG. 4 shows an example of a bicycle R, which is inter alia provided with such wheels 1.

The detail view of FIG. 1 shows a wheel shaft 5 that is driven by means (not shown) that are known per se, which are mechanically driven by manpower or by means of an (auxiliary) motor. The rotary motion of the wheel shaft 5 is in that case transmitted to the rear 1 via the coupling element 6, which is formed by an insert (packing piece) 6-2 in that case, however. The insert rotates along with the wheel shaft 5, because a respective part of the wheel shaft 5 is provided with a combination of teeth as explained above, such as longitudinal ridges 18, and corresponding longitudinal grooves 9. The outer surface of the insert 6-2 is provided with such coupling means 18. The brake 16, which is not shown in the detail view of FIG. 1, may be normally present, of course. If the wheel shaft 5 is driven, the support and the suspension of said wheel shaft will be as shown in FIGS. 3B and 3C. The driving means (not shown) are present in the supporting part 19 in FIG. 3B in that case, or a drive chain is passed over the chain wheel 20 in FIG. 3C, for example. Because the wheel shaft 5, in addition to the bearing forces, must be capable of absorbing a moment, too, when a one-sided suspension is used, it is preferred to use a double-angle contact bearing 6-1, as shown in the detail sectional view of FIG. 2.

As explained in the foregoing, the coupling element 6, which may be a bearing 6-1 or an insert 6-2, is exchangeable in dependence on the fact whether the wheel shaft 5 is a driven shaft or not.

To enable easy mounting and dismounting, and in order to use a minimum amount of individual parts, the central body 2, the coupling element 6, i.e. the shaft bearing 6-1 or the insert 6-2, the housing 7 and possibly the brake 16 can be mutually detached and exchanged.

A preferred manner of producing the wheel, which is to be made in one piece, is by means of the well-known Thixo moulding process.

1. A wheel comprising a hollow central body, in which a coupling element for coupling to a wheel shaft and to the central body is present, wherein the coupling element is a coupling element that is exchangeable depending on whether the wheel shaft is a driven shaft or not.

2. A wheel according to claim 1, wherein the wheel, in the case of a wheel driven by the wheel shaft, comprises an insert as the coupling element.

3. A wheel according to claim 1, wherein the wheel, in the case of a wheel not driven via the wheel shaft, comprises a shaft bearing as the coupling element.

4. A wheel according to claim 1, wherein the central body is provided with internal coupling means to provide a rotatable or rigid coupling with the wheel shaft.

5. A wheel according to claim 1, wherein the wheel comprises a housing which is coupled to the central body in a non-rotatable manner by first coupling means, and the coupling element is coupled to the housing by second coupling means.

6. A wheel according to claim 5, wherein said coupling means has teeth.

7. A wheel according to claim 1, wherein the wheel is provided with a brake.

8. A wheel according to claim 7, wherein said brake is present within the housing.

9. A wheel according to claim 8, wherein said brake is a drum brake.

10. A wheel according to claim 6, wherein at least one pair of the central body, the coupling element, the housing and the brake are mutually detachable and are constructed as exchangeable components.

11. A wheel according to claim 1, wherein the wheel is a vehicle wheel, which may or may not be driven.

12. A wheel according to claim 3, wherein the shaft bearing is a double-angle contact bearing.

13. A wheel according to claim 1, wherein said wheel is dish-shaped.

14. A wheel according to claim 1, wherein the wheel has been produced by means of a Thixo molding process.

15. A vehicle comprising a wheel according to claim 1, wherein the wheel further comprises a hollow central body, having a coupling element for coupling to a wheel shaft and to the central body, wherein the coupling element is a coupling element that is exchangeable depending on whether the wheel shaft is a driven shaft or not.

16. (canceled)
